(19) United States
(12) Patent Application Publication
(10) Pub. No.: US 2007/0234253 A1
(43) Pub. Date: Oct. 4, 2007

(54) Multiple mode approach to building static timing models for digital transistor circuits

(75) Inventors: Jeffrey P. Soreff, Poughkeepsie, NY (US); Philip G. Shephard III, Round Rock, TX (US); Fred L. Yang, Fremont, CA (US); Vasant Rao, Fishkill, NY (US)

Correspondence Address: H. Daniel Schnurmann;Intellectual Property Law, IBM Corporation, Dept. 18G, Building 321-482, 2070 Route 52, Hopewell Junction, NY, 12533, US

(73) Assignee: International Business Machines Corporation, Armonk, NY (US)

(21) Appl. No.: 11/391,880

(22) Filed: Mar. 29, 2006

(51) Int. Cl. G06F 17/50

(52) U.S. Cl. 716/6

(57) ABSTRACT

A method and a system for building static models for transistor circuit design is described. This method includes performing an automatic timing model construction several times on certain problem CCCs, with different, typically incompatible sets of user-selected local information for each call. Each of the sets of local information is considered a mode of operation of the circuit, each generating a timing model for the mode of operation. The resulting set of timing models are placed in parallel in the overall timing graph for the digital design as a whole, which has the effect of making the timing analysis choose the most conservative numbers from across the set of parallel models.

### BACKGROUND OF THE INVENTION

The invention relates to the field of Electronic Design Automation, and more particularly, to a method and a system for performing a static timing analysis on digital transistor circuits.

For many years, the performance of digital machine designs has been evaluated by performing static timing analysis on the designs. Timing Analysis is a design automation tool that provides an alternative to the hardware debugging of timing problems. This program is intended to establish whether all paths within the design meet stated timing criteria, i.e., whether data signals arrive at storage elements early enough for valid gating but not so early as to cause premature gating.

Propagation segments, timing points, the timing graph, arrival times, and timing models:

R. B. Hitchcock, et al., in the article “Timing Analysis of Computer Hardware” published in the IBM J. Res. Develop., Vol. 26, No. 1, January 1982, pp 100-105, and in U.S. Pat. No. 4,263,651, “Method for determining the characteristics of a logic block graph diagram” to Donath et al., there is described a method for providing an indication of path delays between the blocks, in which the output of the program includes a slack at each block to provide a measure of the severity of the timing problems. The program also generates standard deviations for the times so that a statistical timing design can be produced rather than a worst case approach.

In this analysis, the flow of signals through the machine and the delay of the signals, is modeled by a graph of propagation segments referred to as ‘psegs’, each of which describes a delay in the design. By way of example, FIG. 1 shows a 2-input NOR gate with two inputs A and B driving an output Z. Two psegs, one from A to Z and one from B to Z, are present in the timing graph, as shown in FIG. 2. The pseg is considered to extend from an input, referred to as the “from point” of the pseg, to an output, referred to the “to point” of the pseg. Each “timing point” in the timing graph, such as A, B, and Z, holds an “arrival time” or AT, which describes when an incoming signal can reach that point in the design. In the present example, if, for instance, a signal arrives at A at time 2 and a signal arrives at B at time 3, and the delay from A to Z is 5 and the delay from B to Z is 3, then the latest that a signal can arrive at Z is the later of 2+5=7 from the propagation through A to Z, and 3+3=6 from the propagation through B to Z. The latest arrival time at Z is 7, the larger thereof. This value is therefore stored as the (late) arrival time at Z. Delays through wires in a design are similarly represented by psegs. The timing graph for the design as a whole is the full set of all timing points and psegs for all logic circuits and wires in the design, together with “test segments” described below. Each timing point is a vertex of the timing graph, and each pseg is an edge. The set of these elements for an individual logic gate or other subset of the design is the timing model for that subset.

Test segments:

In addition to circuits that perform logical operations and delay signals passing through them, certain types of circuits, such as flip-flops, require that signals arrive in a certain order at their inputs. For example, for data to be stored in a flip-flop, any signal transition on the data input must occur before the clock transition. In fact, the data transition must be prior to the clock transition by a length of time referred to as the setup time. Physically, this is necessary so that, during the clock transition, input data is stable at the valid logical value which is to be latched in the flip-flop, and this is only true after the latest possible data transition is over. In terms of the static timing analysis software, this requires that the data AT be less than the clock AT by at least the setup time. In the timing graph, it is represented by an edge between the data and clock timing points referred to as a “test segment” or tseg. During static timing analysis, once the ATs have been calculated for all timing points, each tseg is checked to determine whether the design satisfies the timing requirement that it represents.

Automatic Timing Model Construction:

In order to perform static timing analysis on a digital design described by a large network of transistors, it is necessary to break the network into partitions and to construct a timing model for each of them. Generally, the network is partitioned into channel-connected-components, CCCs. These are sets of transistors which are interconnected by source and drain (channel) connections, albeit not connections spanning through power supply and ground nets. The task of constructing a timing model for each of the CCCs can have varying complexity, primarily depending on the complexity of the CCC. For example, for a simple combinational CCC, such as a 2-input NOR gate of FIG. 1, the timing model is just a pseg from each input to the single output, and it is easily generated automatically. In more complex cases, existing programs require some user input to help build a correct timing model. To give a highly simplified example, supposing that the user knows that for a particular 2-input NOR gate having two inputs A and B and an output Z, input A always remains low during the operation of the design. In this case, it is valid to omit the pseg from A to Z from the timing model of the NOR gate. Additionally, in this case, the pseg from A to Z can be automatically omitted from the timing model of the NOR gate, since existing programs are able to use this kind of information. Various types of local information which current programs typically use to help construct timing models for CCCs include: a) logical constant information, such as the above case where an input was always low; b) “net constraint” information, e.g., knowing that two input nets and their corresponding input timing points to a CCC are logically equivalent or, alternatively, knowing that two input nets are logically complementary, c) “transistor direction” information, e.g., knowing that data always flows in one direction in a particular transistor; and d) “soft ignore” information, for instance. knowing that a particular transistor or set of transistors should be ignored during the construction of a timing model for a particular CCC. Further details can be found in an article by V. Rao, at al, “EinsTLT: Transistor Level Timing with EinsTimer,” presented at the International Workshop on Timing Issues (TAU), 1999.

Static Timing Analysis and Simulation:

During a static timing analysis, one parameter that is required is the delay through each pseg. For a design consisting of transistors, one way to obtain this information is to perform a simulation on each CCC, measuring the time from when, e.g., each input rises or falls through 50% of the supply voltage until the time when the output rises or falls through 50% of the same voltage. One of the tasks necessary to run these simulations is to properly set up all the input voltages to the CCC and, in some cases, to initialize locations within the CCC or at the CCC's output(s) to certain voltages. Referring again to the previously described example of the 2-input NOR gate having two inputs A and B and output Z, in order to simulate the delay on the pseg from A to Z with a rising signal at A producing a falling signal at Z, while the simulation obviously is required to include a rising voltage source on A, it is also required to set input B at low with a voltage source or a topological connection to ground in the simulation. Depending on the simulator, it may or may not also require for output Z to be initialized high and then left to fall during the simulation. The set of these input voltage settings and node initializations is referred to as a sensitization. Each CCC's psegs requires sensitizations for each delay to be computed.

Automatically Generating Sensitizations:

Current programs can construct sensitizations for their psegs in straightforward cases, and can exploit the same kind of local information that is used to construct the timing model for a CCC. One such technique is simply to use a logic simulator to examine each possible combination of inputs and see which combinations successfully produce a transition on the output. Again, for the previous example of the 2-input NOR gate with inputs A and B and output Z, when the code is attempting to build a pseg from A to Z when attempting to find sensitizations including a rising input on A, the code examines the two possible choices for B, low and high, and finds that only setting B low provides a successful (falling) transition on Z, therefore the code captures the combination of A rising and B falling as a sensitization for this pseg. Current programs also exploit user-supplied local information, e.g., a logic low on B, by accepting only those sensitizations that are consistent with all of the local information.

Timing templates:

Not all the timing models and their psegs' associated sensitizations can be built easily with user-supplied local information. Current programs supply another mechanism referred to as templates, where the user explicitly describes each pseg and tseg in the timing model of the problem CCC, and describes each sensitization for each of the psegs. This provides the user with complete control over the timing analysis performed on the CCC, but it requires voluminous user input to achieve this control. The mechanism for controlling these commands is the well-known technique of extending a Tcl interpreter, details of which are found in the textbook “Practical Programming in Tcl and Tk” by Brent B. Welch published by Prentice-Hall 1997, 2000. Furthermore, additional commands can be incorporated which load the pseg, tseg, and sensitization data structures from the options in the Tcl command without calling automatic timing model construction or automatic sensitization construction.

Practitioners of the art will readily recognize that serious difficulties exist by having the user explicitly specify the psegs, tsegs, and sensitizations with templates that create significant problems in that the volume of user input required can easily become extremely large.

When the user specifies local information, such as logical constants, net constraints, and transistor directions, as previously described, difficulties are encountered in instances where the circuit operation can only be described by incompatible sets of local information that cannot be modeled together. For instance, if one mode requires that two inputs pins be treated as logically equivalent, while another mode requires that the same two input pins be treated as logically complementary, then these two incompatible net constraints cannot both be satisfied by specifying simple local information in a single timing run.

Continually inventing new types of local information to describe what would otherwise be incompatible sets of local information presents problems. For instance, in the example illustrated above, one might invent a new type of logical constraint which asserts that two inputs always switch concurrently, but which are to be examined when both switch in the same direction in some instances, and switch in the opposite direction in others. This has the difficulty that there are a very large number of possible combinations of local information, and adding separate commands and support for each combination requires excessive programming effort.

In U.S. Pat. No. 6,760,894 to Yalcin, et al., there is described a method for performing a timing analysis using a set of modes, each consisting of a set of logical constants applied to the control inputs of circuit blocks, and calculating and storing a fixed delay for each path through the circuit block for each such mode. The method described creates psegs directly from circuit block inputs to outputs, as shown by the paths illustrated in the patent's FIG. 6B.

A difficulty of restricting modes to sets of logical constants on control inputs as described by Yalcin et al., is that it is also useful to be able to specify modes which include logical constants on data inputs, the specification of certain transistors as being ignored during the analysis of the mode, the specification of the direction of data propagation through certain transistors, the specification of logical constraints on sets of inputs, and the specification of certain latch ports as transparent (level-sensitive) or non-transparent (edge-triggered).

A further difficulty of limiting the description of paths in a timing model to fixed delay numbers is that it is also useful to allow precise response of the timing model to variations in loading to input waveform shape, to variations in environmental parameters, such as voltage and temperature, and to variations in transistor characteristics such as those due to process drift.

Still another difficulty exists of limiting the paths in the timing model to paths directly from circuit inputs to circuit outputs is that it is also useful to apply timing-point-specific timing controls, such as phase renames, separately to the timing models of each mode. This last point is described in more detail in the detailed description of the invention.

### OBJECTS AND SUMMARY OF THE INVENTION

Accordingly, it is an object of the invention to provide a method for enabling a user to control a static timing model of a digital transistor circuit, particularly, when timing templates are required.

It is another object to minimize the effort required to control a static timing model of a digital transistor circuit.

It is still another object to reuse existing machinery for automatically generating timing models, currently accounting for consistent local information, extending the use of the machinery to account for multiple separate sets of local information which may be mutually inconsistent.

These and other objects, aspects and advantages of the invention are achieved by performing automatic timing model construction several times on certain problem CCCs, with different, typically incompatible sets of user-selected local information for each call. Each of the sets of local information is considered a mode of operation of the circuit, and each generates a timing model for this mode of operation. The resulting set of timing models are placed in parallel in the overall timing graph for the digital design as a whole, which has the effect of making the timing analysis choose the most conservative numbers from across the set of parallel models.

Local information that describes the modes in the invention is not limited to sets of logical constants on control inputs. More particularly, transistor directions, logical constraints on sets of inputs, which selectively ignore transistors during timing model construction and logical constants on non-control inputs are also included.

The timing model created by an analysis of the modes is not limited to fixed delay numbers, but instead includes sensitizations, which are applied to a simulation when timing analysis is run. This allows precise response of the timing analysis to variations in loading, to input waveform shape, to variations in environmental parameters, such as voltage and temperature, and to variations in transistor characteristics such as those due to process drift.

The timing model creates separate timing points for each operating mode of the circuit, which permits separate application of timing-point-specific user controls, such as phase renames, to the timing models of each mode. This last point is explained in more detail in the detailed description of the invention.

The present invention provides a method and a mechanism for performing a static timing analysis of a circuit design, the circuit design comprising interconnected active devices, the method includes the steps of: a) inputting a topology of the active devices interconnections; b) inputting multiple sets of data descriptive of modes of operation of the circuit design, the multiple sets of data including timing related commands; c) for each data set, constructing a corresponding timing model; d) inputting at least one portion of the timing model into a simulator; and e) inputting selected outputs of the simulator to perform timing analysis of said circuit design.

### BRIEF DESCRIPTION OF THE DRAWINGS

The accompanying drawings, which are incorporated in and which constitute part of the specification, illustrate the presently preferred embodiments of the invention which, together with the general description given above and the detailed description of the preferred embodiments given below serve to explain the principles of the invention.

FIG. 1 shows a diagram of a conventional transistor level schematic of a 2-input NOR gate.

FIG. 2 illustrates a graphical depiction of a prior art timing model of the 2-input NOR gate.

FIG. 3 shows a graphical representation of the topology of a multi-mode version of the timing model for the 2-input NOR, according to the present invention.

FIG. 4 is a flowchart illustrating part of a Tcl command interpreter.

FIG. 5 is a flowchart illustrating the implementation of a start multi mode command.

FIG. 6 is a flowchart illustrating an implementation of a build multi_mode_section command.

FIG. 7 is a flowchart illustrating an implementation of a finish_multi_mode command.

FIG. 8 is a flowchart illustrating an implementation of a set_low command.

FIG. 9 is a flowchart illustrating an implementation of a make_net_group command.

### DETAILED DESCRIPTION

In the following description, for the purposes of explanation, numerous specific details are set forth in order to provide a thorough understanding of the present invention. It will be apparent to those skilled in the art that the present invention may be practiced without these specific details. In other instances, well-known structures and devices are shown in block diagram form in order to avoid unnecessarily obscuring the present invention.

Aspects of the present invention advantageously provide a multiple mode approach to build static timing models for digital transistor circuits. One embodiment of the invention will now be described, wherein at the coarsest level, the flow of information through the new program is the same as through the current static transistor timing code. More particularly:

1. The user writes the topology of a transistor level design to a file

2. The user writes a Tcl commands input file

3. The software reads the transistor topology

4. The software reads the Tcl input file and performs the commands (including some new commands).

5. The software uses timing models to perform static timing analysis.

6. The software writes reports.

Among the novel actions are found new commands added in step 2, and their execution in step 4, which includes the multiple calls to the automatic timing model construction and the infrastructure that supports them. In addition, there is a certain infrastructure in both places that enables local information which is intended for one call to the automatic timing model construction to be distinguished from local information which is intended for a separate call.

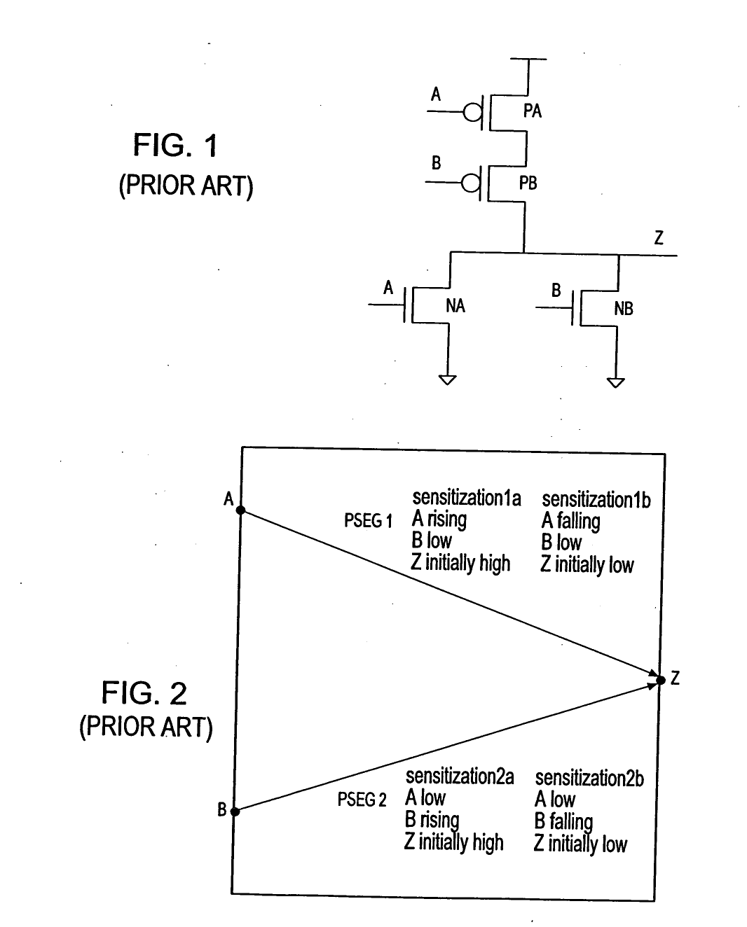

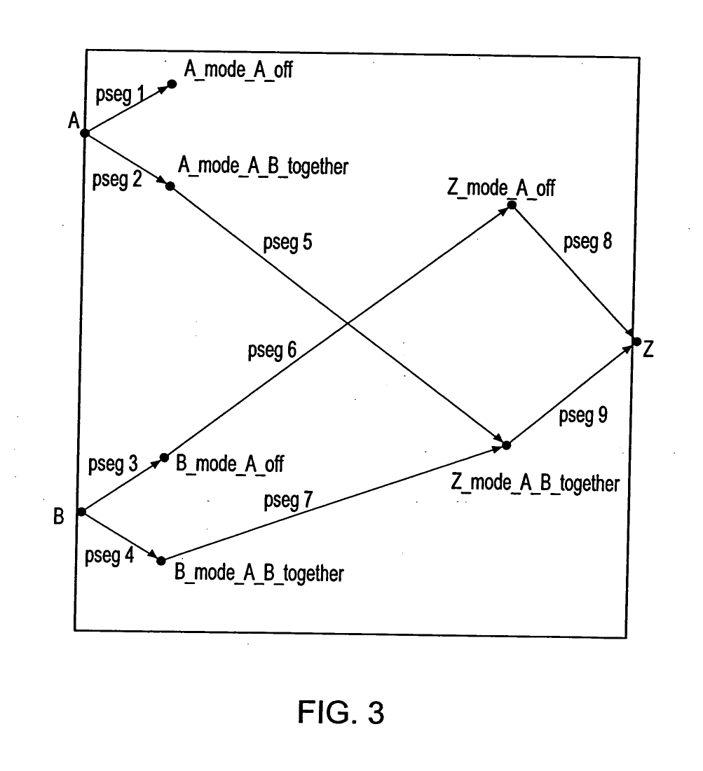

Referring back to the 2-input NOR gate shown in FIG. 1, normally, it would generate the timing model shown in FIG. 2, with two psegs, pseg1 from A to Z, which contains two sensitizations, sensitization1a with A rising, B at low, and Z initially at high, and sensitization1b with A falling, B low, and Z initially low, and pseg2 from B to Z, which contains two sensitizations, sensitization2a with A low, B rising, and Z initially high, and sensitization2b with A at low, B falling, and Z initially at low.

Assuming that the user wants the NOR gate to operate in two modes: mode_A off, where A is held low, and mode_A_B_together, where A and B are logically locked to rise and fall together. Then, the user would write the following commands in a Tcl file: (It is a common practice for CAD applications to provide a scripting language, a language where the end user gives a series of commands which control various internal steps using the CAD application. It is common to do this by adding extensions to the Tcl language, where the extensions are specific to the particular CAD application. The example below is a short sequence of such commands, where the commands themselves are extensions to Tcl added to a static timing analysis CAD program. The commands are executed by subroutines within this CAD programs, and this is described in detail below.)
tlt::start_multi_mode -box_name PA
tlt::set_low -volatile -net A
tlt::build_multi_mode_section -suffix _mode_A_off
tlt::make_net_group -volatile -grouptype equiv -net_names “A B”
tlt::build_multi_mode_section -suffix _mode_A_B_together
tlt::finish_multi_mode

Briefly, the actions of each of these commands are as follows, with additional detail to follow later:
tlt::start_multi_mode -box_name PA
   starts multi mode processing, locates the NOR gate as a whole from PFET PA,
   and, because multi mode processing is now on, makes it legal to issue -volatile local information commands
tlt::set_low -volatile -net A
   sets input A low for the duration of the next multi mode section build
tlt::build_multi_mode_section -suffix _mode_A_off
   builds the pseg and sensitizations for the NOR gate, given that input A is low erases the “set_low” local information
   pulls the new pseg inwards to internal timing points (more on this below)
tlt::make_net_group -volatile -grouptype equiv -net_names “A B”
   locks inputs A and B together logically (making them “equivalent”) for the duration of the next multi mode section build
tlt::build_multi_mode_section -suffix _mode_A_B_together
   builds the psegs and sensitizations for the NOR gate, given A locked to B erases the “equiv” local information
   pulls the new pseg inwards to internal timing points (more on this below)
tlt::finish_multi_mode
   end multi mode processing, and now makes it illegal to issue -volatile local information commands

Referring now to FIG. 3, there is shown a final timing model constructed by this process. It is a bit more complex than one might expect at first glance, due to the creation of some internal timing points, A_mode_A_off, A_mode_A_B_together, B_mode_A_off, B_mode_A_B_together, Z_mode_A_off, Z_mode_A_B_together, and some psegs, pseg1, pseg2, pseg3, pseg4, pseg8, and pseg9, to connect them to the original timing points, A, B, and Z, of the CCC. The motivation for adding the additional timing points is to permit a wide variety of static timing commands which are applied to timing points to be applied separately to the timing model sections created by the new multi mode mechanism. For example, in EinsTimer, a conventional static timing tool, there is a command, rename_phase, which can be applied at a specific timing point.

Leaving aside the details of what this specific command does, one notes that if each mode's psegs went directly from the NOR gate's A and B input timing points to its output Z timing point, there would be no way to selectively apply rename_phase to only the mode_A_off or only the mode_A_B_together section of the final timing model for the NOR gate. By adding the internal timing points, the command can, e.g., be applied to the Z_mode_A_off timing point, which affects only the mode_A_off section. Note that this is only one embodiment of the present invention. Internal points can be created at just inputs, just outputs, or in neither place.

The psegs connecting the original timing pins to the internal timing pins, pseg1, pseg2, pseg3, pseg4, pseg8, and pseg9, are a bit unusual. Unlike normal CCC psegs, they do not have sensitizations. Their purpose is purely to allow ATs from the original timing input pins A and B to flow unchanged to the internal timing points A_mode_A_off, A_mode_A_B_together, B_mode_A_off, and B_mode_A_B_together and the ATs from the internal timing points Z_mode_A_off and Z_mode_A_B_together to flow unchanged to the original output pin Z (where they will be jointly ‘worst-cased’). Since the ATs flow unchanged through these psegs, they have delays of exactly 0, hence they do not need any simulation and, hence, they do not need sensitizations. Although they are integral to the final CCC model, they behave like wire psegs, albeit with zero delay, and, hence, they are referred to as “perfect wires”.

In the final timing model, the psegs which do have sensitizations and do have delays are pseg5, pseg6, and pseg7. Pseg6 is created during the execution of the tlt::build_multi_mode_section -suffix _mode_A_off Tcl command and pseg5 and pseg 7 are created during the execution of the tlt::build_multi_mode_section -suffix _mode_A_B_together Tcl command. In fact, during each of these modes, what happens during the execution of the tlt::build_multi_mode_section Tcl command is that
1. The section's psegs and tsegs are constructed between the CCC's original pins.
2. The internal pins for this mode are generated.
3. The psegs and tsegs are transferred from the original pins to the internal pins.
4. The perfect wires between the original pins and the internal pins are created.

The final sensitizations for pseg6 in FIG. 3 are the same as the sensitizations for the normal models' pseg2 in FIG. 2: sensitization2a with A low, B rising, and Z initially high, and sensitization2b with A low, B falling, and Z initially low. These are unchanged because both of these sensitizations held A low in any event, so forcing it low with the tlt::set_low -volatile -net A did not alter them. It is worth noting that these sensitizations did not have to be altered to refer to the internal pin names. Strictly speaking, the internal names in the sensitizations refer to electrical nets in the original transistor topology, and these are unchanged by the internal timing point names.

In order to avoid unnecessarily obscuring the present invention the original pin names of the NOR gate CCC have been chosen here to agree with the names of the electrical nets that they are connected to, but this is a simplification of the actual naming convention in use.

The final sensitizations for pseg5 and pseg7 in FIG. 3 match each other since nets A and B are interlocked for this section of the timing model. In both cases, there will be a sensitization5a with A rising, B rising, and Z initially high, and there will be a sensitization5b with A falling, B falling, and Z initially low. There is actually a complication involving the net between the PFETs PA and PB, but this is not pertinent to the present invention.

In the example of building the multimode timing model example shown in FIG. 3, the detailed operation of the inventive method is as follows:

Each of the 6 Tcl commands,

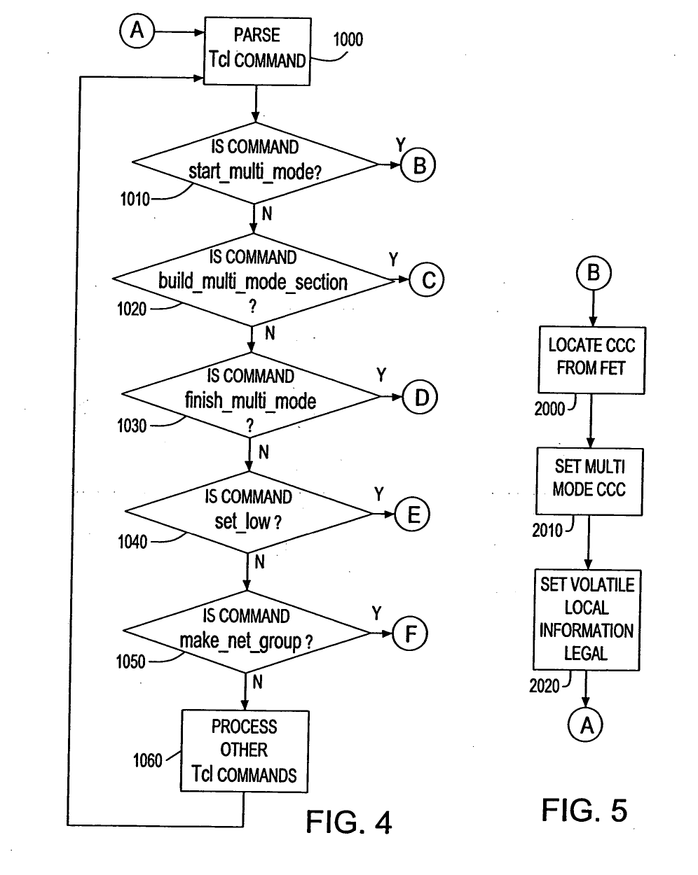

tlt::start_multi_mode -box_name PA
tlt::set_low -volatile -net A
tlt::build_multi_mode_section -suffix _mode_A_off
tlt::make_net_group -volatile -grouptype equiv -net_names “A B”
tlt::build_multi_mode section -suffix _mode_A_B_together
tlt::finish_multi_mode
   is parsed in turn by step 1000 in FIG. 4. Alternatively, each of the lines is broken up into individual tokens by well known techniques. The first of these tokens is the name of the command, such as “tlt::start_multi_mode” or “tlt::set_low”, and this name is used to determine the further processing of the command as shown in FIG. 4.

In the processing of the first command in this example, a tlt::start_multi_mode command, decision block 1010 identifies the command and branches to step 2000 in FIG. 5. Step 2000 takes the name of the transistor from the command, in this case “PA”, and locates the CCC which contains it, in this case, the NOR gate shown in FIG. 1. Step 2010 sets an internal variable referenced to as “theCurCCC”, which refers to the current CCC being processed in the multi mode code, to point to the CCC found in step 2000. Step 2020 sets a flag, “volatileAreSafe”, which declares that it is now legal to set volatile local information, local information which is intended to be erased at the end of a build_multi_mode_section. After step 2020 processing returns to step 1000 to process the next Tcl command.

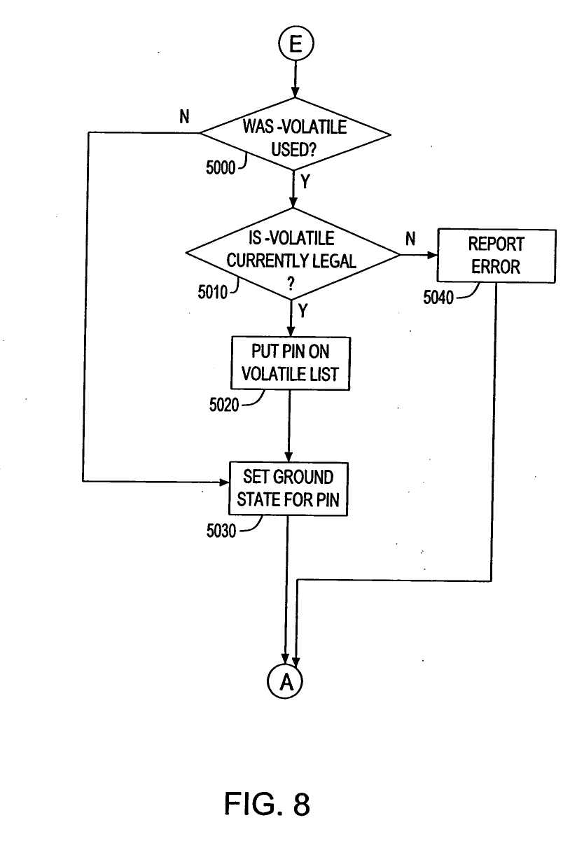

In the processing of the second command in this example, a tlt::set_low command, the command is parsed by step 1000 in FIG. 4, rejected by steps 1010, 1020, and 1030, then dispatched by step 1040 to step 5000 in FIG. 8. Step 5000 determines that volatile local information is being supplied, and proceeds to step 5010 to determine if this is safe, if processing is within processing of a multimode CCC. Since the “volatileAreSafe” flag was set by the previous command, decision block 5010 decides that the volatile local information is legal. Step 5020 then records the input pin on net A on a list of volatile information to be erased after this section of the model building is done. Step 5030 then sets a flag on the pin indicating that it is held at ground (logically low). This step was common to the prior art, and was also used in setting a pin permanently low, which is why the alternate path from decision block 5000 also goes to step 5030 when the set_low command is not volatile. After step 5030 processing returns to step 1000 to process the next Tcl command.

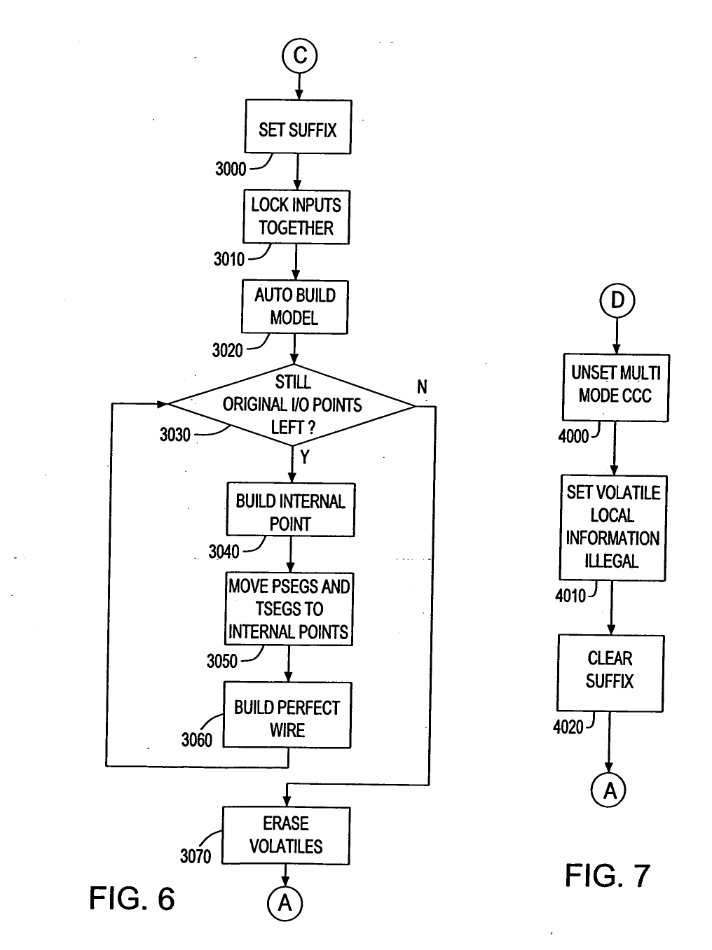

In the processing of the third command of the present example, namely, tlt::build_multi_mode_section command, the command is parsed in step 1000 in FIG. 4, rejected by step 1010, then dispatched by step 1020 to step 3000 in FIG. 6. On this call, step 3000 takes the “_mode_A_off” suffix string from the command and stores it in a variable referred to as “theSuffix” for use by step 3040. During this call, step 3010 does not do anything, since no inputs are locked together.

Step 3020 builds a timing model for the CCC pointed to by “theCurCCC” as set in step 2010. Here, timing model construction uses the fact that input A is set logically at low as set in step 5030 and, as was the prior practice, builds psegs and sensitizations for the NOR gate CCC consistent therewith. On this call, the timing model constructed by step 3020 contains just a pseg identical to pseg2 in FIG. 2, with the same sensitization2a and sensitization2b, as shown there. Immediately, after step 3020, the constructed pseg goes from timing point B to timing point Z, just as was illustrated in FIG. 2.

Steps 3030 through 3060 convert the pseg from B to Z into pseg 6 from B_mode_A_off to Z_mode_A_off in FIG. 3 and add the ‘perfect wires’ pseg1, pseg3, and pseg8 in FIG. 3. Step 3030, and the corresponding return path from step 3060 to 3030 have the effect of looping over all of the timing points at the inputs and outputs of “theCurCCC”, here timing points A, B, and Z. Steps 3040, 3050, and 3060 are executed for each of these timing points. In this call, the first call to step 3030 finds timing point A, and falls through to step 3040. Step 3040 takes timing point A and appends “theSuffix”, “_mode_A_off”, to create internal timing point A_mode_A_off. Step 3050 would normally move a new pseg to the new timing point, but, since A is set low on this call to building the model, no pseg is constructed from it this time and no pseg is moved this time. Step 3060 builds a perfect wire, pseg 1 in FIG. 3, from A to A_mode_A_off, then branches back to step 3030. Step 3030 now finds timing point B, and falls through to step 3040. Step 3040 takes timing point B, appends “_mode_A_off”, and creates internal timing point B_mode_A_off. Step 3050 takes the new pseg from B to Z and moves its source to the new B_mode_A_off, so the pseg now goes from B_mode_A_off to Z. Step 3060 now connects B to B mode_A_off with the perfect wire pseg 3. Finally, step 3030 now finds timing point Z and falls through to step 3040. Step 3040 builds internal timing point Z_mode_A_off from timing point Z. Step 3050 takes the pseg from B_mode_A_off to Z and moves it to its final location as pseg 6 in FIG. 3, from B_mode_A_off to Z_mode_A_off. Step 3040 then connects Z_mode_A_off to Z with the pseg 8 perfect wire. Step 3030 then finds that all input and output timing points of “theCurCCC” have been processed and falls through to step 3070.

Step 3070 erases the local information that was used in this build_multi_mode_section so that it does not interfere with the construction of the next section. For this call, it erases the volatile set_low on A, so that this logical constant will be removed from the next model build, in the next call to step 3020. Step 3070 uses the list of volatiles built up in step 5020. It erases all of the local information at all of the locations that are pointed to by the list, then it erases the list itself. Note that the “-volatile” mechanism is not the only possible way to prevent local information in one mode's model build from interfering with the next model build. One alternative is to provide commands for the users to explicitly erase local information after each multi mode section build.

After step 3070 processing returns to step 1000 to process the next Tcl command.

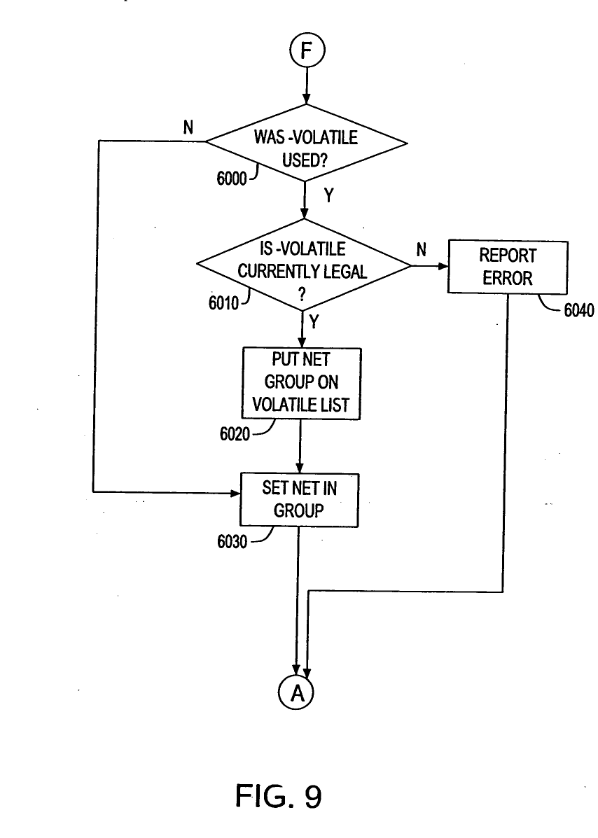

In the processing of the fourth command in this example, a tlt::make_net_group command, the command is parsed by step 1000 in FIG. 4, rejected by steps 1010, 1020, 1030, and 1040, then dispatched by step 1050 to step 6000 in FIG. 9. As in the processing of the second command, decision blocks 6000 and 6010 find that this is a -volatile command, and that it is legal in this context. Step 6020 records that the logical group formed from nets A and B is a volatile one, and places it in a list analogous to the volatile list constructed by step 5020. Step 6030 records that the group formed from nets A and B treats them as logically equivalent, so that they will rise and fall together in the next model construction for “theCurCCC”. After step 6030 processing returns to step 1000 to process the next Tcl command.

In the processing of the fifth command in this example, a tlt::build_multi_mode_section command, the command is parsed by step 1000 in FIG. 4, rejected by step 1010, then dispatched by step 1020 to step 3000 in FIG. 6. On this call, step 3000 takes the “_m_mode_A_B_together” suffix string from the command and stores it in “theSuffix” for use by step 3040. On this call, step 3010 takes the group recorded by step 6030, and uses it to treat inputs A and B to the NOR gate as if they were a single, synchronized, logical input, with A and B rising together and falling together. As in the prior art, step 3020 then creates a timing model for “theCurCCC” which is topologically the same as FIG. 2, with psegs from both timing points A and B to Z. As in the prior art, the sensitizations for these psegs lock A and B together, with both psegs containing a sensitization5a with A rising, B rising, and Z initially high, and both containing a sensitization5b with A falling, B falling, and Z initially low. As with the processing of the previous call to build_multi_mode_section, steps 3030 through 3060 restructure the graph, here converting the two new psegs from A and B to Z into pseg 5 from A_mode_A_B_together to Z_mode_A_B_together and pseg 7 from B_mode_A_B_together to Z_mode_A_B_together, respectively. These steps also add in the perfect wire psegs: pseg 2, pseg 4, and pseg 9, completing the multi-mode model for the NOR gate theCurCCC. Step 3070 then walks through the list of volatile local information, in this case the net group constructed by step 6020, and erases the group and then the list. After step 3070 processing returns to step 1000 to process the next Tcl command.

In the processing of the final, sixth, command in this example, a tlt::finish_multi_mode command, the command is parsed by step 1000 in FIG. 4, rejected by steps 1010, and 1020, then dispatched by step 1030 to step 4000 in FIG. 7. Step 4000 clears the “theCurCCC” variable, so the multimode processing no longer is directed to the NOR gate CCC it was processing. Step 4010 clears the “volatileAreSafe” flag, indicating that it is no longer legal to assert volatile local information. Step 4020 clears “theSuffix”, since it is no longer needed to build internal timing points, which was completed on the last call to step 3040. After step 4020 processing returns to step 1000 to process the next Tcl command.

The present example illustrates the processing of one NOR gate CCC in detail. In a typical run, multimode processing would be called many times on many separate CCCs.

While the present invention has been particularly described in conjunction with a specific preferred embodiment, it is evident that many alternatives, modifications and variations will be apparent to those skilled in the art in light of the present description. It is therefore contemplated that the appended claims will embrace any such alternatives, modifications and variations as falling within the true scope and spirit of the present invention.

1. A method of performing a static timing analysis of a circuit design, said circuit design comprising interconnected active devices, the method comprising the steps of:
a) inputting a topology of the active devices interconnections;
b) inputting multiple sets of data descriptive of modes of operation of said circuit design, said multiple sets of data comprising timing related commands;
c) for each data set, constructing a corresponding timing model;
d) inputting at least one portion of said tiling model into a simulator, and
e) inputting selected outputs of said simulator to perform timing analysis of said circuit design.

2. The method of claim 1, wherein in step b) said timing commands are selected from the group consisting of: (i) logical constants on specified nodes or pins of the circuit design; (ii) instructions to temporarily ignore the presence of selected transistors in the circuit design; (iii) specification of a direction of a signal flow through selected transistors in the circuit design; (iv) constraints on a specified Boolean function of a set of locations in the circuit design; and (v) specification of whether a particular port of a latch is edge-triggered or level-sensitive.

3. The method of claim 1, wherein in step e) said outputs of said simulator comprise delays, output slews, and piecewise linear waveforms at circuit outputs.

4. The method of claim 3, wherein in step e) said selected outputs are inputted into a static timing analyzer that is applicable to portions or to the entire circuit design.

5. The method of claim 1, wherein said active devices are transistors.

6. The method of claim 1, wherein said circuit design is partitioned into a plurality of subsets.

7. The method of claim 6, wherein at least one said subset is a CCC.

8. The method of claim 6, wherein said multiple sets of data descriptive of modes of operation are an input to for at least one subset of the said circuit design.

9. The method of claim 1, wherein in step c) said timing models comprise a plurality of propagation segments and test segments.

10. The method of claim 9, wherein said propagation segments comprise: i) ‘from’ timing points, ii) ‘to’ timing points, and iii) N sensitizations, wherein N is an integer greater than or equal to 0.

11. The method of claim 1, wherein in step c) said timing model comprises a plurality of propagation segments which each have a “from” timing point directly attached to an input of the circuit design, and which each have a “to” timing point directly attached to an output of the circuit design

12. The method of claim 1, wherein in step c) said timing model comprises a plurality of propagation segments at least one of which has a “to” point on a timing point which is in the interior of the circuit design, and is neither an input of the circuit design nor an output of the circuit design.

13. The method of claim 1, wherein in step c) said timing model comprises a plurality of propagation segments, wherein for each mode of operation, a propagation segment from each circuit input is connected to an interior timing point corresponding to said mode of operation and to said circuit input.

14. The method of claim 1, wherein in step c) said timing model comprises a plurality of propagation segments, wherein for at least one mode of operation, at least one propagation segment from a circuit input is connected to an interior timing point that corresponds to said mode and to that circuit input.

15. The method of claim 1, wherein in step c) said timing model comprises a plurality of propagation segments, wherein for each mode of operation, a propagation segment to each circuit output is connected from an interior timing point corresponding to said mode of operation and to said circuit output.

16. The method of claim 1, wherein in step c) said timing model comprises a plurality of propagation segments, wherein for at least one mode of operation, at least one propagation segment to a circuit output is connected from an interior timing point that corresponds to said mode of operation and to that circuit output.

17. The method of claim 1, wherein in step c) after constructing said timing model, at least a portion of the data set for said current mode of operation is erased, and an entry of a corresponding portion of said data set for the next mode of operation is allowed without requiring an additional input from a user to avoid conflict between portions of said data set for the current and the next mode of operation.

18. The method of claim 1, wherein in step d) a portion of said timing model comprises a sensitization that includes a plurality of specifications of voltage sources consisting of DC or changing signals, said voltage sources being applied to the inputs of said circuit, said sensitization further comprising specifications of initial voltages on internal nodes of said circuit.

19. A system for performing a static timing analysis of a circuit design, said circuit design comprising interconnected active devices, the system comprising:
a) means for inputting a topology of the active devices interconnections;
b) means for inputting multiple sets of data descriptive of modes of operation of said circuit design, said multiple sets of data comprising timing related commands;
c) for each data set, means for constructing a corresponding timing model;
d) means for inputting at least one portion of said timing model into a simulator; and
e) means for inputting selected outputs of said simulator to perform timing analysis of said circuit design.

20. A program storage device readable by a machine, tangibly, embodying a program of instructions executable by the machine for performing method steps to execute a static timing analysis of a circuit design, said circuit design comprising interconnected active devices, said method steps comprising:
a) inputting a topology of the active devices interconnections;
b) inputting multiple sets of data descriptive of modes of operation of said circuit design, said multiple sets of data comprising timing related commands;
c) for each data set, constructing a corresponding timing model;
d) inputting at least one portion of said timing model into a simulator; and
e) inputting selected outputs of said simulator to perform timing analysis of said circuit design.
